(19) United States
(12) Patent Application Publication
(10) Pub. No.: US 2026/0243393 A1
(43) Pub. Date: Aug. 20, 2026

(54) GAS SUPPLY SYSTEM FOR HIGH- AND LOW PRESSURE GAS-CONSUMING DEVICES AND METHOD FOR CONTROLLING SUCH A SYSTEM

(71) Applicant: GAZTRANSPORT ET TECHNIGAZ, Saint Remy Les Chevreuse (FR)

(72) Inventors: Bernard AOUN, Saint Remy Les Chevreuse (FR); Charbel HOMSY, Saint Remy Les Chevreuse (FR); Romain NARME, Saint Remy Les Chevreuse (FR)

(73) Assignee: GAZTRANSPORT ET TECHNIGAZ, Saint Remy Les Chevreuse (FR)

(21) Appl. No.: 18/852,621

(22) PCT Filed: Mar. 15, 2023
(86) PCT No.: PCT/FR2023/050362

§ 371 Date: Sep. 30, 2024

(30) Foreign Application Priority Data
Apr. 7, 2022 (FR) FR2203214

(51) Int. Cl. F17C 7/04

(52) U.S. Cl. CPC F17C 7/04; F17C 2221/033; F17C 2223/0161; F17C 2225/0123; F17C 2227/0135; F17C 2227/0306; F17C 2227/0393; F17C 2250/0439; F17C 2250/0636; F17C 2265/034; F17C 2265/066; F17C 2270/0105

(57) ABSTRACT

A supply system for supplying a high-pressure gas-consuming device and a low-pressure gas-consuming device of a floating structure comprising a tank, the supply system includes a first supply circuit, a second supply circuit, a return line, a first heat exchanger and a second heat exchanger, the supply system including at least one branch for cooling the gas withdrawn in the vapour state from the tank, connected to the second supply circuit upstream of the compression device, the supply system including at least one heat exchanger configured to operate a heat exchange between the vapour-state gas flowing through the cooling branch and the liquid-state gas flowing through the first supply circuit.

The present invention relates to the domain of ships to store and/or transport liquid-state gas and relates more specifically to a gas supply system for gas-consuming devices that such ships comprise, and to a control process of such a system.

During a journey by a ship comprising a tank of liquid-state gas for consumption and/or delivery to a destination point, said ship should be able to use at least a part of said liquid-state gas to feed at least one of its motors through a gas supply system. This is the case of ships with a ME-GI high-pressure propel engine. To feed such motors, the gas must be compressed to extremely high pressure by special compression devices that are able to compress the gas up to 300 bar absolute, but such compression devices are expensive, generate sizable maintenance costs and induce vibrations in the ship.

An alternative to the installation of such high-pressure compression devices is to boil off liquid-state gas at 300 bar absolute, in particular with a high-pressure pump, before it is sent to the propel engine. Since such a solution cannot remove the vapor-state gas (boil-off gas, BOG) that naturally forms in a tank that at least partially contains the cargo, it is possible to mount a low-pressure compression means to feed an auxiliary motor that is able to consume the gas as a low-pressure vapor. The excess vapor-state gas can also circulate to the tank by recondensation.

The efficiency of such a system is already high, but it remains possible to increase the global performance of this system. Indeed, a drawback of this system is the variations of the temperature of the vapor-state gas from the tank. There are cases where this temperature tops a threshold that, eventually, induces an increase of the consumption of the low-pressure compression means, in particular of its power consumption.

Another drawback is the great amount of energy required by the vaporization of the liquid-state gas to reach 300 bar absolute.

The present invention aims at solving these problems by proposing a gas supply system of at least one high-pressure gas-consuming device and of at least one low-pressure gas-consuming device for a floating structure comprising at least a tank configured to contain the gas at least in liquid state, wherein the gas supply system comprises:
at least a first gas supply circuit for the high-pressure gas-consuming device,
at least a high-pressure evaporator configured to evaporate the gas that flows through the first gas supply circuit,
at least a second gas supply circuit for the low-pressure gas-consuming device comprising at least a compression device configured to compress some gas removed from the tank in vapor state up to a pressure that is compatible with the needs of the low-pressure gas-consuming device,
at least a gas return line connected to the second supply circuit downstream from the compression device and extending to the tank,
at least a first heat exchanger and at least a second heat exchanger, wherein each of them is configured to implement a heat exchange between the vapor-state gas flowing through the return line and the liquid-state gas flowing through the first gas supply circuit.

The gas supply system is innovative in that it comprises at least a cooling branch for the gas removed in vapor state from the tank connected to the second supply circuit upstream from the compression device, wherein the gas supply system comprises at least one thermal exchanger comprising at least a first line on the first gas supply circuit between the second heat exchanger and the high-pressure evaporator and a second line on the cooling branch.

The cooling branch makes the vapor-state gas from the tank diverge from a part of the second gas supply circuit. This way, the gas is sent to the thermal exchanger that implements a cooling of the gas that flows through the cooling branch thanks to the liquid-state gas flowing through the first gas supply circuit. The heat exchange is all the more effective than it is made between a liquid-state gas and a vapor-state gas. Thus, the cooling branch and its thermal exchanger are interesting in the case of feeding a low-pressure gas-consuming device or in the case of liquefying the excess of gas from the tank blanket. The densification of the vapor-state gas after flowing through the thermal exchanger makes it possible to reduce the power consumption of the compression device by up to 30% when the vapor-state gas flows through the return line to be condensed. This reduction of the power consumption of the compression device can reach 45% when the vapor-state gas flows through the second gas supply circuit to be provided to the low-pressure gas-consuming device.

The first gas supply circuit makes it possible to fulfill the fuel requirements of the high-pressure gas-consuming device. It can be, for example, the propulsion means of the floating structure, for example a ME-GI motor. The first supply circuit extends from the tank to the high-pressure gas-consuming device. The pump is located at the bottom of the tank and pumps the liquid-state gas, so that it can flow through the first gas supply circuit.

Since the gas must be in vapor state to feed the high-pressure gas-consuming device, the high-pressure evaporator provides for the evaporation of the gas before feeding the high-pressure gas-consuming device. The high-pressure evaporator is the location of a heat exchange between the liquid-state gas in the first gas supply circuit and a heat transfer fluid, for example water glycol, sea water or water vapor. This heat transfer fluid, no matter its kind, must have a temperature high enough to generate a phase change of the gas, so that it turns to vapor or supercritical state to feed the high-pressure gas-consuming device.

The second gas supply circuit extends from the tank to the low-pressure gas-consuming device. This can be, for example, an auxiliary motor, such as an internal combustion engine of an electric generator. The function of the compression device on the second gas supply circuit is to suck the gas from the blanket of the tank to both feed the low-pressure gas-consuming device and regulate the pressure in the tank.

At the outlet of the compression device, the vapor-state gas can feed the low-pressure gas-consuming device and/or circulate through the return line if the low-pressure gas-consuming device needs no or little fuel supply. Since the return line is connected downstream from the compressor, the vapor-state gas that is sucked by the compression device can circulate through it.

The vapor-state gas in the return line first flows through the second heat exchanger, then through the first heat exchanger, before returning to the tank. In this configuration, thanks to the heat exchange between the liquid-state gas through the first heat exchanger and the vapor-state gas through the return line, the temperature of the vapor-state gas decreases through the two heat exchangers until said gas condenses substantially downstream from the first heat exchanger. Then, the condensed gas, in liquid state, flows to the tank.

According to a characteristic of the invention, the thermal exchanger comprises at least a first line on the first gas supply circuit upstream from the high-pressure evaporator and a second line on the cooling branch. So, the liquid-state gas that flows through the first gas supply circuit first flows through the thermal exchanger, then flows through the first line of the high-pressure evaporator.

According to another characteristic, the first line of the thermal exchanger is located between the second heat exchanger and the high-pressure evaporator. Here, it shall be understood that the liquid-state gas that flows through the first gas supply circuit first flows through the first line of the first heat exchanger, then flows through the first line of the thermal exchanger and then flows through the first line of the high-pressure evaporator.

The successive heat exchanges implemented by the variants above take advantage of the calories from one and/or the other of the relevant fluids in an order that increases the efficiency of the system.

According to another characteristic of the invention, the second line of the thermal exchanger is located upstream from the compression device according to the direction of the gas flow through the second gas supply circuit. Thus, the vapor-state gas flows into the compression device at a lower temperature, which makes it possible to increase the density of the gas, hence to reduce the flow volume of the compression device.

According to another characteristic of the invention, the gas supply system comprises a divergence point, where the cooling branch and the second supply circuit separate, and a convergence point, where the cooling branch and the second supply circuit join, wherein the cooling branch extends between the divergence point and the convergence point. The divergence point and the convergence point delimit a part of the second gas supply circuit, and so the cooling branch is mounted parallel to this part.

Advantageously, the second gas supply circuit comprises at least one monitoring unit for the circulation of the gas through said second gas supply circuit, wherein the cooling branch is mounted parallel to the monitoring unit of the circulation of gas through said second gas supply circuit. Thus, the monitoring unit is located on the part of the second gas supply circuit.

In this condition, the divergence point is located upstream from the monitoring unit for the circulation of the gas through said second gas supply circuit, and the convergence point is located downstream from said monitoring unit according to the direction of flow through said second gas supply circuit.

Advantageously, the cooling branch comprises at least a monitoring valve for the gas flow through said cooling branch. So, the gas flow through the thermal exchanger is monitored, in particular through its second line.

For example, the monitoring unit and/or the monitoring valve can be an on-off valve.

The gas supply system of the invention can as well comprise at least a measurement means for the temperature of the gas removed in vapor state from the tank and a management device that commands at least the monitoring unit of the gas flow through said second gas supply circuit and the monitoring valve for the gas flow through said cooling branch. The measurement means assesses or measures, directly or indirectly, the temperature of the vapor-state gas removed from the tank.

The management device is able to allow the circulation of gas through the cooling branch when the temperature as measured by the measurement means is higher than a reference threshold. Furthermore, the management device is able to prevent the circulation of gas through the cooling branch when the temperature as measured by the measurement means is lower than the reference threshold.

Interestingly, the first gas supply circuit comprises a pump between the first heat exchanger and the second heat exchanger. The pump, called high-pressure pump, makes it possible to increase the pressure of the liquid-state gas through the first gas supply circuit, so that its pressure is compatible with the feeding of the high-pressure gas-consuming device.

According to a first example of implementation, the high-pressure evaporator and the thermal exchanger constitute a single heat exchanger module.

Alternatively, the second heat exchanger and the thermal exchanger constitute a single heat exchanger module. In combination, at least the high-pressure evaporator, the second heat exchanger and the thermal exchanger constitute a single heat exchanger module. This single heat exchanger module is only one heat exchanger with at least three, four or five lines that are fluidically distinct from each other.

According to a characteristic of the invention, the gas supply system comprises a heat treatment branch of the vapor-state gas that flows through the return line, wherein the heat treatment branch is connected to the second gas supply circuit upstream from the compression device, the gas supply system comprising a third heat exchanger configured to implement a heat exchange between the vapor-state gas through the heat treatment branch and the vapor-state gas through the return line. The heat treatment branch and the third heat exchanger make it possible to take advantage of the cold in the vapor-state gas removed from the tank to yield it to the vapor-state gas flowing through the return line in order to make the liquefaction of this gas easier.

According to a characteristic of the invention, the first gas supply circuit comprises at least one pump to suck the liquid-state gas removed from the tank. The pump is advantageously a submerged pump at the bottom of the tank to remove the liquid-state gas and to circulate it through the first gas supply circuit. When the liquid-state gas is sucked by the pump, its pressure is increased to a value between 6 and 17 bar absolute.

The invention also relates to a control process for a gas supply system as described in this document, wherein:
at a measurement step, the temperature of the vapor-state gas removed from the tank is measured, then
the vapor-state gas is circulated through the cooling branch if the temperature of the vapor-state gas as measured at the measurement step is higher than a reference threshold, or
the vapor-state gas is circulated through the second gas supply circuit if the temperature of the vapor-state gas as measured at the measurement step is lower than the temperature threshold.

In other words, if the temperature of the gas removed in vapor state from the tank is higher than the reference threshold, the monitoring valve of the gas flow through the cooling branch allows the circulation of gas through said cooling branch. If the temperature of the gas removed in vapor state from the tank is lower than the reference threshold, the monitoring valve of the gas flow through the cooling branch prevents the circulation of gas through said cooling branch. According to the selected reference threshold, the process allows the gas to flow through said second gas supply circuit by opening a monitoring unit for the circulation of the gas through the second gas supply circuit and prevents the gas flow through the return line, for example by closing the flowrate regulation unit.

The measurement step is implemented by the measurement means for the vapor-state gas removed from the tank. The management device implements the comparison between this measured temperature and the reference threshold, and the resulting choice.

The system reaches a good level of efficiency when the reference threshold is −90° C., in particular +/−10%, the process comprising then a step of condensation of the vapor-state gas through the return line.

According to an aspect of the invention, when the reference threshold is not less than −150° C., the process comprises a step of feeding the low-pressure gas-consuming device via the second gas supply circuit.

Other characteristics and advantages of the invention will appear thanks to the following description, on one hand, and thanks to several embodiments produced as a guide and non-limitative with a reference to the appended schematic pictures, on the other hand, where:

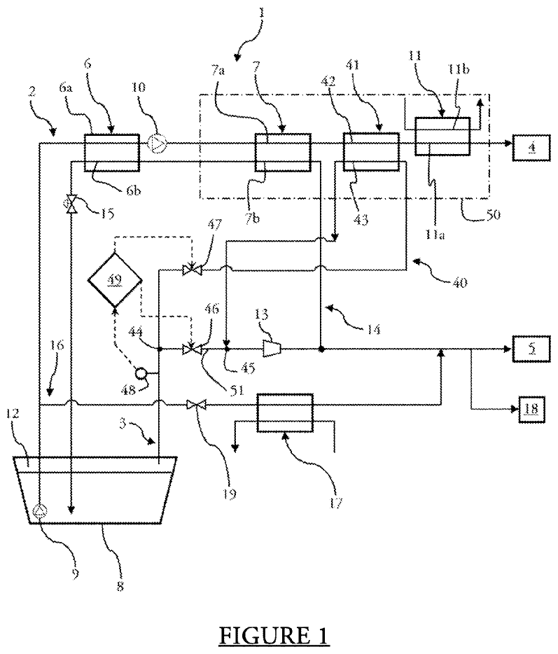

FIG. 1 is a schematic view of a gas supply system according to the invention,

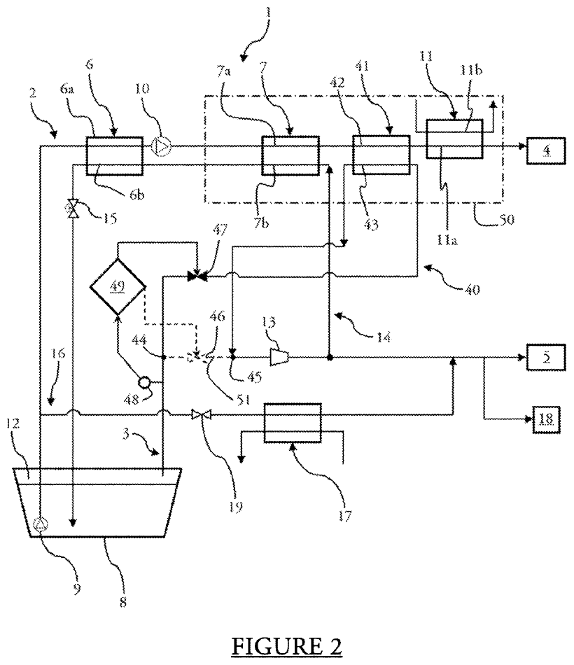

FIG. 2 is a schematic view of a gas supply system of FIG. 1 in a first operational status,

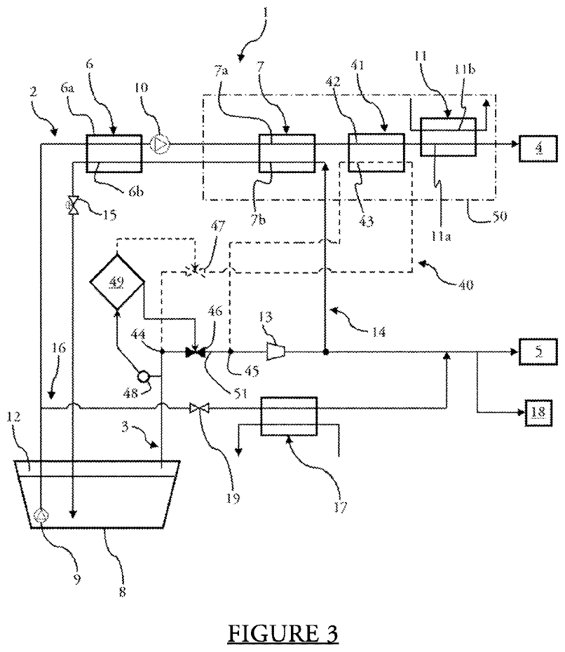

FIG. 3 is a schematic view of a gas supply system of FIGS. 1 and 2 in a second operational status,

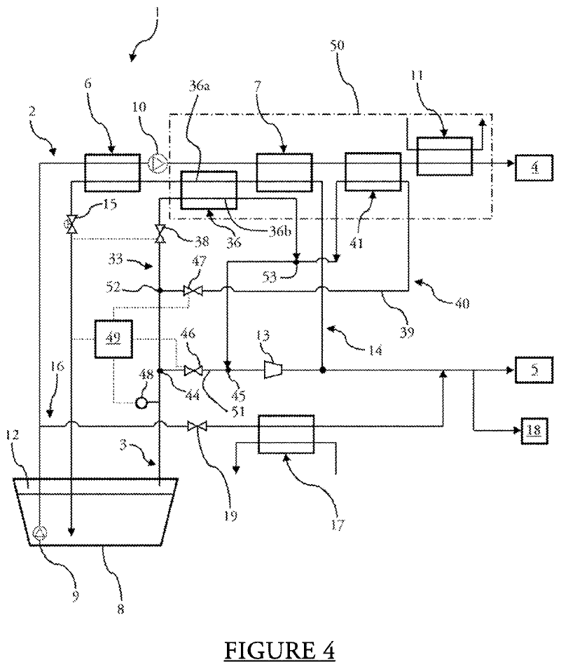

FIG. 4 is a schematic view of a gas supply system according to the invention according to another embodiment.

The following description uses the words upstream and downstream to define the relative position of components in the liquid-state or vapor-state gas circuitry, with reference to the direction of flow of said gas through said circuitry.

Identical items keep the same reference no matter the figures where they appear.

FIG. 1 shows a gas supply system 1 embarked on a floating structure. The gas supply system 1 makes it possible to circulate gas under liquid state, vapor state, two-phased or under supercritical state from a storing and/or transport tank 8 to a high-pressure gas-consuming device 4 and to a low-pressure gas-consuming device 5 in order to feed them with fuel.

Said floating structure can be, for example, a LNG-carrier-type ship that can store and/or transport liquid-state gas, in particular natural gas. In this case, the gas supply system 1 is able to use the liquid-state gas that the floating structure stores and/or transports to feed the high-pressure gas-consuming device 4, which can be, for example, a propel engine, and the low-pressure gas-consuming device 5, which can be, for example, an electric generator that powers the floating structure.

To guarantee the circulation of the gas from the tank 8 to the high-pressure gas-consuming device 4, the gas supply device 1 comprises a first gas supply circuit 2. The first gas supply circuit 2 comprises a submerged pump 9 located in the tank 8. The submerged pump 9 makes it possible to pump the liquid-state gas and to circulate it, in particular through the first gas supply circuit 2. By sucking the liquid-state gas, the submerged pump 9 increases its pressure up to a value between 6 and 17 bar absolute.

From the tank 8 to the high-pressure gas-consuming device 4, the liquid-state gas flows through a first heat exchanger 6 and is pressurized by a pump 10 that is also called high-pressure pump. Later, the liquid-state gas flows through the second heat exchanger 7, then through a high-pressure evaporator 11, before reaching the high-pressure motor 4. The pump 10 is advantageously located between the first heat exchanger 6 and the second heat exchanger 7.

The high-pressure evaporator 11 makes it possible to change the state of the gas flow through the first gas supply circuit 2 to turn it to vapor or supercritical state.

Such a state is compatible with feeding the high-pressure gas-consuming device 4. The evaporation of the liquid-state gas can be made, for example, by heat exchange between the liquid-state gas flowing into the high-pressure evaporator 11 and a heat transfer fluid at a temperature high enough to boil off the liquid-state gas, here water glycol, sea water or water vapor.

The increase of the gas pressure is provided by the pump 10 when it pumps the liquid-state gas. The pump 10 makes it possible to increase the pressure of the liquid-state gas up to a value between 30 and 400 bar absolute, notably for use with ammonia or hydrogen, between 30 and 70 bar absolute for use with liquefied petroleum gas, and preferably between 150 and 400 bar absolute for use with ethane, ethylene, or with a liquefied natural gas predominantly made of methane.

Thanks to the combination of the pump 10 and the high-pressure evaporator 11, the gas is at a pressure and in a state that are compatible with feeding the high-pressure gas-consuming device 4. Such a configuration makes it possible to avoid the installation of high-pressure compression devices on the first gas supply circuit 2, which have cost constraints and generate strong vibrations.

In the tank 8, a part of the gas cargo can naturally turn to vapor and spread into the tank blanket 12. To prevent too much pressure in the tank 8, the vapor-state gas in the tank blanket 12 must be bled.

Thus, the gas supply system 1 comprises a second gas supply circuit 3 that uses the vapor-state gas to feed the low-pressure gas-consuming device 5. The second gas supply circuit 3 extends between the tank blanket 12 and the low-pressure gas-consuming device 5. To suck the vapor-state gas contained in the tank blanket 12, the second gas supply circuit 3 comprises a compression device 13, in particular a compressor. In addition to sucking the vapor-state gas, the compression device 13 also makes it possible to compress the vapor-state gas through the second gas supply circuit 3 up to a pressure between 6 and 20 bar absolute so that the vapor-state gas reaches a pressure compatible with feeding the low-pressure gas-consuming device 5. The second gas supply circuit 3 makes it possible to feed the low-pressure gas-consuming device 5 while regulating the pressure in the tank 8 by sucking the vapor-state gas from the tank blanket 12.

Too much vapor-state gas in the tank blanket 12 leads to too much pressure in the tank 8. So, it is necessary to bleed the vapor-state gas to reduce the pressure in the tank 8. Then, for example, the excessive vapor-state gas can be removed by a burner 18, or, in a not pictured way, can be released into the atmosphere. These solutions lead to a loss of cargo.

That is why the gas supply system 1 according to the invention comprises a return line 14 that extends from the second gas supply circuit 3 to the tank 8.

The return line 14 is connected to the second gas supply circuit 3 downstream from the compression device 13 with reference to a direction of flow of the vapor-state gas through the second gas supply circuit 3. The return line 14 first extends through the second heat exchanger 7, then on through the first heat exchanger 6.

The first heat exchanger 6 comprises a first line 6a that is part of the first gas supply circuit 2. This first heat exchanger 6 comprises a second line 6b that is part of the return line 14. The direction of flow through the first line 6a is opposite to the direction of flow through the second line 6b of the first heat exchanger 6.

The second heat exchanger 7 is located between the first heat exchanger 6 and the high-pressure evaporator 11 on the first gas supply circuit 2.

The second heat exchanger 7 comprises a first line 7a that is part of the first gas supply circuit 2. This second heat exchanger 7 comprises a second line 7b that is part of the return line 14. The direction of flow through the first line 7a is opposite to the direction of flow through the second line 7b of the second heat exchanger 7.

The liquid-state gas of the first gas supply circuit 2 has its lowest temperature at the inlet of the first line 6a of the first heat exchanger 6.

This way, the gas that flows through the return line 14 is condensed after flowing through the first heat exchanger 6. Thus, the fluid in the return line 14 is under vapor state at the inlet of the second line 6b of the first heat exchanger 6 and flows out under liquid state after heat exchange in the first heat exchanger 6.

The return line 14 further comprises a flowrate regulation unit 15 that monitors the flowrate of the fluid through the return line 14. This flowrate regulation unit 15 has a flow area that can be modified. Once the gas is condensed, it flows to the tank 8. Thus, the first heat exchanger 6 is used as a condenser while the flowrate regulation unit 15 monitors the heat exchange in the first heat exchanger 6, in the second heat exchanger 7 and in the high-pressure evaporator 11.

The gas supply system 1 also comprises an auxiliary gas supply line 16 that extends from the first gas supply circuit 2 through a nipple between the submerged pump 9 and the first heat exchanger 6 to the second gas supply circuit 3 with connection to it between the compression device 13 and the low-pressure gas-consuming device 5. The auxiliary gas supply line 16 makes it possible to feed the low-pressure gas-consuming device 5 in case of insufficient vapor-state gas flowrate from the tank blanket 12.

When there is not enough vapor-state gas in the tank blanket 12, the liquid-state gas from the submerged pump 9 can flow through this auxiliary gas supply line 16 to feed the low-pressure gas-consuming device 5. To do so, the auxiliary gas supply line 16 extends through a low-pressure evaporator 17, so that the liquid-state gas that flows through the auxiliary gas supply line 16 turns to vapor. For example, the operation of the low-pressure evaporator 17 can be the same as the high-pressure evaporator 11, which means the gas is boiled off by heat exchange with a heat transfer fluid at a temperature high enough to boil off the liquid-state gas. At the outlet of the low-pressure evaporator 17, the vapor-state gas flows through the auxiliary gas supply line 16, then reaches the second gas supply circuit 3 to feed the low-pressure gas-consuming device 5.

The hereabove implies that the auxiliary gas supply line 16 is used only when there is not enough vapor-state gas in the tank blanket 12.

Thus, the auxiliary gas supply line 16 comprises a valve 19 that monitors the gas flow through the auxiliary gas supply line 16 when its use is not necessary.

According to the invention, the gas supply system 1 comprises at least one cooling branch 40 for the vapor-state gas removed from the tank. Such a branch makes it possible to circulate the vapor-state gas removed from the tank 8 to cool it.

The cooling branch 40 is fluidically connected to the second gas supply circuit 3 upstream from the compression device 13. That is the way the gas supply system comprises a divergence point 44 in the second gas supply circuit 3 and where the cooling branch 40 starts. The gas supply system 1 further comprises a convergence point 45, where the second gas supply circuit 3 and the cooling branch 40 join. The divergence point 44 and the convergence point 45 are both located on the second gas supply circuit 3 before the compression device 13.

The gas supply system 1 also comprises a thermal exchanger 41 intended to cool the vapor-state gas removed from the tank by heat exchange with the liquid-state gas that flows through the first supply circuit 2.

This thermal exchanger 41 comprises a first line 42 that exchanges heat with a second line 43 part of this thermal exchanger 41. The first line 42 of the thermal exchanger 41 is part of the first gas supply circuit 2 with the liquid-state gas flowing through it, while the second line 43 of the thermal exchanger 41 is part of the cooling branch 40 with the vapor-state from the tank 8 flowing through it.

Ingeniously, the first line 42 of the thermal exchanger 41 is fluidically located between the first line 7a of the second heat exchanger 7 and the first line 11a of the high-pressure evaporator 11.

Such a location makes it possible to cool the vapor-state gas that flows through the cooling branch 40 by heat exchange with the liquid-state gas that flows through the first gas supply circuit 2, which eventually makes it possible to reduce the flow volume at the inlet of the compression device 13, hence to reduce its consumption, in particular its power consumption.

This location also makes it possible to reduce the flowrate of heat transfer fluid through a second line 11b of the high-pressure evaporator 11 to boil off the liquid-state gas from the tank 8. Since it is a hot source, the invention makes it possible to reduce the amount of calories that the heat transfer fluid provides, since a part of the calories is provided by the vapor-state gas that flows through the cooling branch 40.

The circulation of the vapor-state gas through the second gas supply circuit 3 is designed under the control of a monitoring unit 46. For example, the latter is a valve. The circulation of the vapor-state gas through the cooling branch 40 is designed under the control of a monitoring valve 47. This monitoring unit and/or this monitoring valve is, for example, a valve or an on-off valve.

The cooling branch 40 is mounted parallel to this monitoring unit 46. In other words, the divergence point 44 is located upstream from the monitoring unit 46 of the gas flow through the second gas supply circuit 3, while the convergence point 45 is located downstream from this same monitoring unit 46.

The gas supply system also comprises a management device 49 and at least one measurement means 48 for the temperature of the vapor-state gas removed from the tank 8. The measurement means 48 of the temperature is, for example, a temperature sensor located on the second gas supply circuit 3 between the tank and the divergence point 44. Alternatively, the sensor can be mounted in the tank blanket 12.

This measurement means 48 of the temperature is electrically connected to the management device 49, since the data from the measurement means 48 is used in a calculation implemented by the management device 49.

This management device 49 is an electronic control module that receives the data from the measurement means 48 and that monitors the opening and the closing of the monitoring unit 46 and/or of the monitoring valve 47. The management device 49 implements the process and its various steps, except the step of measurement of the temperature of the vapor-state gas removed from the tank 8.

The process of the invention is illustrated by FIG. 2 and FIG. 3.

The management device 49 is able to allow the circulation of gas through the cooling branch 40, when the temperature of the vapor-state gas removed from the tank 8 and measured by the measurement means 48 is higher than a temperature threshold, wherein such a temperature threshold is, for example, equal to −90° C., when the vapor-state gas mostly or exclusively flows through the return line 14. Alternatively, the reference threshold is not lower than −150° C. when the vapor-state gas is mostly or exclusively sent to the low-pressure gas-consuming device 5 via the second gas supply circuit 3. In such a case, the flowrate regulation unit 15 reduces the flowrate through the return line 14 or possibly stops it completely.

The management device 49 operates the opening of the monitoring valve 47, which so allows the vapor-state gas removed from the tank 8 to reach the thermal exchanger 41, in particular its second line 43. In such a situation, the management device 49 prevents the vapor-state gas from flowing through a part 51 of the second gas supply circuit 3 extending between the divergence point 44 and the convergence point 45. To do so, the management device 49 operates a closing of the monitoring unit 46 mounted on the part 51.

As shown in FIG. 3, the management device 49 is also able to prevent the circulation of gas through the cooling branch 40, when the temperature as measured by the measurement means 48 is lower than the above-mentioned reference threshold. To do so, the management device 49 operates a closing of the monitoring valve 47. In such a case, the management device 49 allows the vapor-state gas to flow through the part 51 of the second gas supply circuit 3 by operating the opening of the monitoring unit 46, hence allowing the vapor-state gas removed from the tank 8 to directly reach the compression device 13.

Of course, the management device 49 can be assigned to other calculation operations required for the function of the gas supply system 1 according to the invention, for example the monitoring of the flowrate regulation unit 15 or the monitoring of the valve 19 that controls the flow of gas through the auxiliary gas supply line 16 or the monitoring of the compression device 13 or the monitoring of the submerged pump 9 or of the pump 10.

It shall be noted that each heat exchanger described in this document can be a two-line component. The invention also covers the case where heat exchangers are gathered to constitute a single heat exchanger, for example a three- or four-line heat exchanger. Thus, the high-pressure evaporator and the thermal exchanger 41, or the second heat exchanger 7 and the thermal exchanger 41, or the combination of these three components, can constitute a single heat exchanger module 50.

FIG. 4 shows the gas supply system of FIGS. 1 to 3 with additional components added.

Thus, this gas supply system 1 of FIG. 4 additionally comprises a heat treatment branch 33 for the vapor-state gas that flows through the return line 14. This heat treatment branch 33 is intended to take part in the cooling of the vapor-state gas that flows through the return line to make its condensation easier. In this situation, the heat treatment branch 33 makes it possible to collect the cold from the vapor-state gas removed from the tank 8 and to valorize it by yielding to the return line 14.

The heat treatment branch 33 is connected to the second gas supply circuit 3 upstream from the compression device 13 via a divergence zone 52 and a convergence zone 53 specifics to the heat treatment branch 33. Alternatively, the heat treatment branch 33 and the cooling branch 40 can both be connected to the divergence point 44 and to the convergence point 45. Whatever the connection mode, the heat treatment branch 33 and the cooling branch are mounted parallel to each other and to the part 51 of the second gas supply circuit 3.

FIG. 4 also shows a third heat exchanger 36 configured to implement a heat exchange between the vapor-state gas through heat treatment branch 33 and the vapor-state gas through the return line 14. Such a third heat exchanger 36 comprises a first line 36a part of the return line 14 located between the second line 6b of the first heat exchanger 6 and the second line 7b of the second heat exchanger 7. This third heat exchanger 36 comprises a second line 36b that is part of the heat treatment branch 33.

The heat treatment branch 33 further comprises a monitoring device 38 configured to monitor the flow of the vapor-state gas through the heat treatment branch 33. This monitoring device 38 is designed under the control of the management device 49 and is in open position when the temperature of the vapor-state gas removed from the tank 8, as measured by the measurement means 48, is lower than a temperature threshold, for example equal to −110° C.

When the temperature of the vapor-state gas, as measured by the measurement means, is higher than the temperature threshold, the management device 49 operates the closing of the monitoring device 38 and circulates the vapor-state gas through the second gas supply circuit 3.

According to an interesting aspect of FIG. 4, it is suitable to manage the circulation of flows between the cooling branch 40 and the heat treatment branch 33. That is the way the process of the invention notably specifies that, when the temperature of the vapor-state gas as measured at the measurement step by the measurement means 48 is lower than the temperature threshold, only the vapor-state gas is circulated through the heat treatment branch 33.

Complementarily, when the temperature of the vapor-state gas as measured at the measurement step by the measurement means 48 is lower than the temperature threshold, only the vapor-state gas is circulated through the cooling branch 40. Eventually, when the temperature of the vapor-state gas as measured at the measurement step by the measurement means 48 is between the temperature threshold and the reference threshold, only vapor-state gas is circulated through the second gas supply circuit 3.

In the case of FIG. 4, the above-mentioned single heat exchanger module 50 can be complemented with the third heat exchanger 36. Such a single heat exchanger module 50 can then comprise at least five lines that are fluidically separated from each other.

Of course, the invention is not restricted to the examples above, and many refinements may be added to these examples in the framework of the invention.

The invention, as described above, reaches the goal it was assigned and suggests a gas supply system that reduces the power consumption of the compression device and/or of the high-pressure evaporator. Variants that are not described here could be implemented in the frame of the invention as soon as, according to the invention, they comprise a gas supply system according to the invention.

1. A gas supply system of at least one high-pressure gas-consuming device and at least one low-pressure gas-consuming device for a floating structure comprising at least a tank configured to contain the gas at least in liquid state, wherein the gas supply system comprises:
at least a first gas supply circuit for the high-pressure gas-consuming device,
at least a high-pressure evaporator configured to boil off the gas that flows through the first gas supply circuit,
at least a second gas supply circuit for the low-pressure gas-consuming device comprising at least a compression device configured to compress some gas removed from the tank in vapor state up to a pressure that is compatible with the needs of the low-pressure gas-consuming device,
at least a gas return line connected at the second supply circuit downstream from the compression device and extending to the tank,
at least a first heat exchanger and a second heat exchanger, wherein each of them is configured to implement an heat exchange between the gas flowing through the return line and the liquid-state gas flowing through the first gas supply circuit,
wherein the gas supply system comprises at least a cooling branch for the gas removed in vapor state from the tank connected to the second supply circuit upstream from the compression device, wherein the gas supply system comprises at least one thermal exchanger configured to implement a heat exchange between the vapor-state gas through the cooling branch and the liquid-state gas through the first supply circuit.

2. The gas supply system according to claim 1, wherein the thermal exchanger comprises at least a first line on the first gas supply circuit upstream from the high-pressure evaporator and a second line on the cooling branch.

3. The gas supply system according to claim 2, wherein the first line of the thermal exchanger is located between the second heat exchanger and the high-pressure evaporator.

4. The gas supply system according to claim 3, wherein the second line of the thermal exchanger is located upstream from the compression device according to the direction of the gas flow through the second gas supply circuit.

5. The gas supply system according to claim 1, comprising a divergence point where the cooling branch and the second supply circuit separate, and a convergence point where the cooling branch and the second supply circuit join, wherein the cooling branch extends between the divergence point and the convergence point.

6. The gas supply system according to claim 1, wherein the second gas supply circuit comprises at least one monitoring unit for the circulation of the gas through said second gas supply circuit, wherein the cooling branch is mounted parallel to the monitoring unit of the circulation of gas through said second gas supply circuit.

7. The gas supply system according to claim 6, wherein the cooling branch comprises at least a monitoring valve for the gas flow through said cooling branch.

8. The gas supply system according to claim 7, comprising at least one measurement means for the temperature of the gas removed in vapor state from the tank, and a management device that commands at least the monitoring unit of the gas flow through said second gas supply circuit and the monitoring valve for the gas flow through said cooling branch.

9. The gas supply system according to claim 1, wherein the first gas supply circuit comprises a pump between the first heat exchanger and the second heat exchanger.

10. The gas supply system according to claim 1, wherein at least the high-pressure evaporator and the thermal exchanger constitute a single heat exchanger module.

11. The gas supply system according to claim 1, wherein at least the high-pressure evaporator, the second heat exchanger and the thermal exchanger constitute a single heat exchanger module.

12. The gas supply system according to claim 1, comprising a heat treatment branch of the vapor-state gas through the return line, wherein the heat treatment branch is connected to the second supply circuit upstream from the compression device, the gas supply system comprising a third heat exchanger configured to implement a heat exchange between the vapor-state gas through the heat treatment branch and the vapor-state gas through the return line.

13. A control process for the gas supply system according to claim 1, wherein:
at a measurement step, the temperature of the vapor-state gas removed from the tank is measured, then
the vapor-state gas is circulated through the cooling branch if the temperature of the vapor-state gas as measured at the measurement step is higher than a reference threshold, or
the vapor-state gas is circulated through the second gas supply circuit if the temperature of the vapor-state gas as measured at the measurement step is lower than the reference threshold.

14. The control process according to claim 13, where the reference threshold is −90° C., wherein the control process comprises a step of condensation of the vapor-state gas through the return line.

15. The control process according to claim 14, where the reference threshold is not less than −150° C., wherein the process comprises a step of feeding the low-pressure gas-consuming device via the second gas supply circuit.
